(19) United States
(12) Patent Application Publication
(10) Pub. No.: US 2023/0377160 A1
(43) Pub. Date: Nov. 23, 2023

(54) METHOD AND ELECTRONIC DEVICE FOR ACHIEVING ACCURATE POINT CLOUD SEGMENTATION

(71) Applicant: SAMSUNG ELECTRONICS CO., LTD., Suwon-si (KR)

(72) Inventors: Rajat Kumar JAIN, Maharashtra (IN); Aditi Singhal, Uttar Pradesh (IN); Sujoy Saha, Karnataka (IN); Rajas Jayant Joshi, Maharashtra (IN); Amita Badhwar, Punjab (IN); Mansi Singh, Uttar Pradesh (IN); Lokesh Rayasandra Boregowda, Karnataka (IN)

(73) Assignee: SAMSUNG ELECTRONICS CO., LTD., Suwon-si (KR)

(21) Appl. No.: 18/198,023

(22) Filed: May 16, 2023

Related U.S. Application Data
(63) Continuation of application No. PCT/KR2023/006299, filed on May 9, 2023.

(30) Foreign Application Priority Data
May 19, 2022 (IN) 202241028840
Feb. 10, 2023 (IN) 202241028840

(51) Int. Cl. G06T 7/11; G06F 3/01; G06T 15/80; G06T 15/40; G06T 5/00; G06T 5/20; G06T 7/50; G06T 17/00

(52) U.S. Cl. CPC G06T 7/11; G06F 3/011; G06T 15/80; G06T 15/40; G06T 5/002; G06T 5/20; G06T 7/50; G06T 17/00; G06T 2207/10028; G06T 2207/20084; G06T 2207/20081

(57) ABSTRACT

There is provided a method for segmenting a point cloud by an electronic device. The method includes receiving the point cloud including colorless data and/or featureless data. Further, the method includes determining a normal vector for the received point cloud and/or a spatial feature for the received point cloud. Further, the method includes segmenting the point cloud based on the at least one of one or more normal vectors and one or more spatial features.

### CROSS-REFERENCE TO RELATED APPLICATION(S)

This application is a continuation of International Application No. PCT/KR2023/006299 designating the United States, filed on May 9, 2023, in the Korean Intellectual Property Receiving Office and claiming priority to Indian Provisional Application Number 202241028840, filed on May 19, 2022, and Indian Patent Application No. 202241028840, filed on Feb. 10, 2023, in the Indian Patent Office, the disclosure of which is incorporated by reference herein in its entirety.

### BACKGROUND

### 1. Field

The disclosure relates to image processing, and more particularly, a method and an electronic device for performing image processing to achieve accurate point cloud segmentation.

### 2. Description of Related Art

Point cloud (also referred to as “three-dimensional (3D) point cloud”) has recently gained popularity as a result of advancement in Augmented Reality (AR) and Virtual Reality (VR) and its numerous applications in computer vision, autonomous driving, and robotics. A process of classifying point clouds into different homogeneous regions so that the points in a same isolated and meaningful region have similar properties, is known as point cloud segmentation (i.e., 3D point cloud segmentation). The point cloud segmentation process is useful for analyzing a scene in a variety of applications such as object detection and recognition, classification, and feature extraction.

Related art deep learning mechanisms have been successfully used to solve two-dimensional (2D) vision problems; however, the use of existing deep learning mechanisms on point clouds is still in its infancy due to unique challenges associated with point cloud processing. Some related art deep learning approaches overcame this challenge by pre-processing the point cloud into a structured grid format, but at the expense of increased computational cost or loss of depth information. The 3D point cloud segmentation is a difficult process due to high redundancy, uneven sampling density, and a lack of explicit point cloud structure (i.e., point cloud data). The segmentation of the point cloud into foreground and background is a critical step in 3D point cloud processing. In 3D data space (such as 3D point cloud), one can precisely determine and segment a shape, a size, and other properties/features (e.g., color information/Red, Green, and Blue (RGB) information, texture information, density information, etc.) of an object without difficulty, whereas segmenting the objects with limited features in the 3D point cloud is a difficult task since data in the 3D point cloud is noisy, sparse, and disorganized.

Accurate point cloud segmentation is a critical step in creating a smooth interactive environment. Related art segmentation methods present numerous methodologies to generate point cloud segmentation, but none address the cases where the point cloud lacks sufficient features. For example, in a scenario in which a user is wearing an AR headset and exploring a surrounding environment, the AR headset has multiple cameras that provide a visual understanding of the environment. However, because of their low power consumption, the cameras currently mounted on the AR headset are grayscale cameras, which capture sequential frames as the user explores the environment. The sequential frames are then used to generate a 3D map of the surrounding environment using well-known techniques such as Structure-From-Motion, Simultaneous Localization and Mapping, and so on. Since the cameras are grayscale, the 3D map generated will be colorless and hence well-known segmentation methods cannot be used as they usually use textural/density features along with various geometrical features. Thus, it is desired to address the above-mentioned disadvantages or other shortcomings and/or provide a novel method for achieving accurate point cloud segmentation.

### SUMMARY

According to an aspect of the disclosure, there is provided a method for performing point cloud segmentation, the method including: receiving, by an electronic device, a point cloud including at least one of colorless data and featureless data; determining, by the electronic device, at least one of one or more normal vectors and one or more spatial features for one or more vertices in the point cloud; and segmenting, by the electronic device, the point cloud based on the at least one of the one or more normal vectors and the one or more spatial features.

The method may further include: detecting, by the electronic device, at least one input from a user of the electronic device to place at least one object in a virtual environment; determining, by the electronic device, an optimal empty location to place the at least one object in the virtual environment based on the segmented point cloud; and displaying, by the electronic device, the virtual environment including the at least one object placed in the optimal empty location of the virtual environment.

The segmenting the point cloud based on the at least one of the one or more normal vectors and the one or more spatial features may include: determining a similarity score for the one or more vertices in the point cloud based on the at least one of the one or more normal vectors and the one or more spatial features; determining an attention score based on the at least one of the one or more normal vectors, the one or more spatial features, and the similarity score; determining a global feature vector of the point cloud based on the at least one of the one or more normal vectors, the one or more spatial features, the similarity score, and the attention score; and segmenting the point cloud based on at least one of the similarity score, the attention score, and the global feature vector.

The attention score may be generated using Fully Connected (FC) layers of at least one neural network.

The method may include updating, by the electronic device, the attention score by updating weights of Fully Connected (FC) layers of at least one neural network by back-propagating a loss determined using a segmentation controller such that a new attention score is determined in a next iteration; and repeating the updating operation until training is completed, wherein the loss incorporates Eigen values to provide accurate segmentation around at least one edge and at least one corner in the point cloud.

The displaying the virtual environment including the at least one object placed in the optimal empty location of the virtual environment may include: determining a scale and an orientation of the at least one object in the optimal empty location; determining a Model View and Projection Matrix (MVP) based on the determined scale and the determined orientation of the at least one object; and determining a shade of the at least one object based on a real-world illustration and an occlusion of at least one real-world object based on the segmented point cloud.

The receiving the point cloud including the at least one of the colorless data or the featureless data may include: capturing a plurality of image frames of a real-world environment using at least one sensor of the electronic device; and determining the point cloud of the real-world environment from the plurality of image frames using at least one image processing mechanism.

The determining the one or more normal vectors for the one or more vertices in the point cloud may include: filtering at least one of a noise and an outlier from the point cloud by applying at least one of an adaptive filter and a selective filter; determining a plane tangent to a surface around each of the one or more vertices in the point cloud; and determining the one or more normal vectors based on the determined plane tangent.

The determining the spatial feature for the received point cloud may include: filtering at least one of a noise and an outlier from the point cloud by applying at least one of an adaptive filter and a selective filter; determining a region of a first radius around each vertex in the point cloud and at least one principal component for a subset of three dimensional (3D) points in the region; determining at least one principle Eigen vector from the at least one determined principle component; and determining a mean depth of the subset of 3D points in the region around each of the one or more vertices.

The determining the global feature vector may include: propagating at least one vertex, among the one or more vertices in the point cloud, along with geometrical features and the one or more spatial features through a series of encoding layers of at least one neural network, wherein each of the series of encoding layers obtains geometry information in the point cloud using the geometrical features and the one or more spatial features, and outputs an encoded feature vector that is passed onto a subsequent encoding layer, among the series of encoding layers; determining that the encoded feature vector is half of the input to that particular layer; and determining the global feature vector by encoding information passed through multiple encoding layers, among the series of encoding layers.

The method may further include: detecting, by the electronic device, a viewing direction of a user using the electronic device to see at least one object in a virtual environment based on the segmented point cloud; determining, by the electronic device, an optimal empty location associated with the viewing direction based on the segmented point cloud, wherein the optimal empty location includes at least one plane associated with the viewing direction in the segmented point cloud and depth information of the at least one plane; and displaying, by the electronic device, the virtual environment with the at least one object in the optimal empty location of the virtual environment.

According to another aspect of the disclosure, there is provided an electronic device including: a memory; a segmentation controller, coupled to the memory, and configured to: receive a point cloud including at least one of colorless data and featureless data; determine at least one of one or more normal vectors and one or more spatial features for one or more vertices in the point cloud; and segment the point cloud based on the at least one of the one or more normal vectors and the one or more spatial features.

### BRIEF DESCRIPTION OF THE DRAWINGS

The above and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications. One or more example embodiments of the disclosure are illustrated in the accompanying drawings, throughout which like reference letters indicate corresponding parts in the various figures. The embodiments herein will be better understood from the following description with reference to the drawings, in which:

FIG. 1 illustrates a block diagram of an electronic device for segmenting a point cloud, according to an example embodiment of the disclosure;

FIG. 2 is a flow diagram illustrating a method for segmenting the point cloud, according to an example embodiment of the disclosure;

FIG. 3 is an example flow diagram illustrating various operations for segmenting the point cloud, according to an example embodiment of the disclosure;

FIG. 4A is an example flow diagram illustrating various operations for Feature Extraction and Attention Calculation.

FIG. 4B is an example flow diagram illustrating various operations for segmenting the point cloud, according to another embodiment of the disclosure;

FIG. 5 illustrates various use cases of implementing the point cloud segmentation method, according to an example embodiment of the disclosure;

FIG. 6 illustrates an example scenario in which a user of the electronic device places an object at an optimal location in a virtual environment based on the segmented point cloud, according to an example embodiment of the disclosure; and

FIG. 7 illustrates an example scenario in which the user of the electronic device sees the object at the optimal location in the virtual environment based on the segmented point cloud, according to an example embodiment of the disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, may be implemented by a hardware, a software or a combination of hardware and software. These blocks may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

According to an aspect of the disclosure, there is provided a method for enabling an electronic device to perform segmentation on a point cloud, such as a colorless/featureless point cloud, by defining one or more additional features from the colorless/featureless point cloud. The one or more additional features include the normal vector/direction (e.g., a direction of a plane tangent to a surrounding surface at a given vertex) and the one or more spatial features (e.g., mean depth, Eigenvectors of the surrounding surface for every vertex, where the surrounding surface includes a volume of radius r centered at the vertex). The normal direction is determined for every vertex in the point cloud. As a result, the accuracy of the segmentation on the point cloud improves, allowing for a smooth interactive environment (e.g., AR/VR). The method may directly use the one or more additional features in the segmentation/classification without the need for pre-processing to determine one or more local features (e.g., edge), and the method may also use the one or more additional features for loss calculation to improve prediction associated with the segmentation. Furthermore, the size of the point cloud/processing time/computation time will be reduced as the proposed method does not use color information/less data for the segmentation without affecting the accuracy. The method does not require a color sensor since the method does not use color information/less data for the segmentation, which is cost-saving.

According to an aspect of the disclosure, there is provided a method for an electronic device to determine the one or more additional features for all encoding layers of a neural network for the segmentation after the down-sampling of the point cloud.

According to an aspect of the disclosure, there is provided a method for an electronic device to generate one or more global features which is then decoded with a skip connection to provide a segmented point cloud with dimension information (e.g., N×C dimension where N is a number of the vertex in a filtered point cloud and C is a number of classes for which the segmentation was performed).

According to an aspect of the disclosure, there is provided a method for an electronic device to receive an input colorless/featureless point cloud, estimate the normal vector/direction of the input colorless/featureless point cloud and concatenate them as one or more features, estimate the one or more spatial features in this case Eigen vectors of the surrounding surface for each vertex at different sampling levels (e.g. 0.5, 0.25, 0.125, 0.0625) from the input colorless/featureless point cloud, along with vertex depth as additional features for learning and understanding spatial characteristics. Then, the electronic device calculates one or more similarity scores for the features explained above and learns one or more attention scores using multiple fully connected layers, provides supervision using the one or more attention scores, along with the one or more features as input to the segmentation controller at multiple sampling levels to generate segmentation output and using the Eigen vectors in a loss function to improve upon segmentation at an edge and a corner.

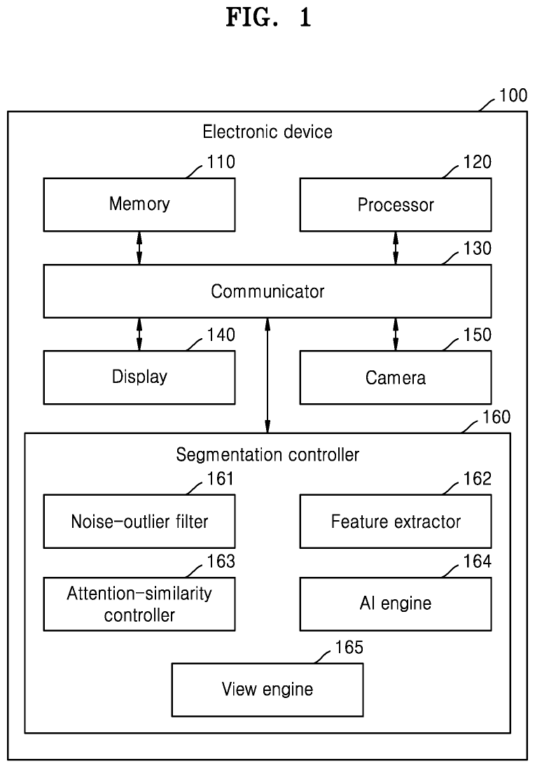

Referring now to the drawings and more particularly to FIGS. 1 through 7, where similar reference characters denote corresponding features consistently throughout the figures, there are shown preferred embodiments.

FIG. 1 illustrates a block diagram of an electronic device 100 for segmenting a point cloud, according to an example embodiment of the disclosure. Examples of the electronic device 100 include, but are not limited to a smartphone, a tablet computer, a Personal Digital Assistance (PDA), an Internet of Things (IoT) device, an AR device, a VR device, a wearable device, etc.

In an example embodiment, the electronic device 100 includes a memory 110, a processor 120, a communicator 130, a display 140, a camera 150, and a segmentation controller 160.

In an example embodiment, the memory 110 stores a normal vector associated with a point cloud, a spatial feature associated with the point cloud, a similarity score of each vertex associated with the point cloud, an attention score, a global feature vector, a Model View and Projection Matrix (MVP), a plurality of image frames, and other information associated with the point cloud. The memory 110 stores instructions to be executed by the processor 120. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit or it can be an external storage unit of the electronic device 100, a cloud storage, or any other type of external storage.

The processor 120 communicates with the memory 110, the communicator 130, the display 140, the camera 150, and the segmentation controller 160. In an example embodiment, the processor 120 communicates with the memory 110, the display 140, the camera 150, and the segmentation controller 160 through the communicator 130. The processor 120 is configured to execute instructions stored in the memory 110 and to perform various processes. According to an example embodiment, the processor 120 may execute the instructions to control one or more operations of the communicator 130, the display 140, the camera 150, and the segmentation controller 160. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 130 is configured for communicating internally between internal hardware components and with external devices (e.g. eNodeB, gNodeB, server, etc.) via one or more networks (e.g. Radio technology). The communicator 130 includes an electronic circuit specific to a standard that enables wired or wireless communication. The display 140 may include a touch panel and/or sensors configured to accept user inputs. According to an example embodiment, the display 140 may be a liquid crystal display (LCD), a light-emitting diode (LED) display, an organic light-emitting diode (OLED) display, or another type of display. The user inputs may include but are not limited to, touch, swipe, drag, gesture, voice command, and so on. The camera 150 includes one or more cameras to capture the one or more image frames.

According to an example embodiment, the segmentation controller 160 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an example embodiment, the segmentation controller 160 includes a noise-outlier filter 161, a feature extractor 162, an attention-similarity controller 163, an Artificial Intelligence (AI) engine 164, and a view engine 165. However, the disclosure is not limited thereto, and as such, according to another example embodiment, the segmentation controller 160 may include other components and/or omit one or more of the components illustrated in FIG. 1. According to another example embodiment, one or more of the noise-outlier filter 161, the feature extractor 162, the attention-similarity controller 163, the AI engine 164, and the view engine 165 may be combined as a single component or may be provided as separate components.

The noise-outlier filter 161 receives the point cloud that includes colorless data and/or featureless data, where the point cloud is determined based on a plurality of image frames of a real-world environment. According to an example embodiment, the point cloud that includes colorless data and/or featureless data may be a point cloud without RGB values. However, the disclosure is not limited thereto, and as such, according to another example embodiment, the point cloud may be without other feature values. The plurality of image frames are captured using a sensor of the electronic device 100. For example, the plurality of image frames may be captured by an image sensor or the camera 150. The noise-outlier filter 161 filters or removes noise and/or an outlier from the received point cloud. According to an example embodiment, the noise-outlier filter 161 may apply an adaptive filter and/or a selective filter on the received point cloud to remove noise and/or outlier from the received point cloud. The noise-outlier filter 161 filters or removes the noise and/or the outlier by eliminating points that are at a distance more than a threshold value. The threshold value may be a predetermined value or a known value. In other words, the noise-outlier filter 161 divides the point cloud into patches, fits the data to a normal distribution, and filters out points that are more than a certain distance apart from the threshold value. The points that are not within the threshold value are discarded, and rest of the points are used. According to an example embodiment, the noise-outlier filter 161 may out points that are not within a range.

The feature extractor 162 determines a plane tangent to a surface around each vertex associated with the point cloud and determines the normal vector for the received point cloud and/or the spatial feature for the received point cloud. For example, the feature extractor 162 determines the normal vector of the plane tangent to the surface around each and every vertex. Moreover, the feature extractor 162 determines the one or more spatial features such as mean depth, Eigenvector, etc. According to an example embodiment, the feature extractor 162 analyzes around the surrounding surface (e.g., within a radius “r” around the vertex as center) and obtains top Eigenvectors for the one or more similarity scores and the loss calculation. In other words, the feature extractor 162 analyzes the Eigenvectors of the surrounding surface for each vertex at different sampling levels (e.g. 0.5, 0.25, 0.125, and 0.0625) from the input colorless/featureless point cloud, along with vertex depth as additional features for learning and understanding spatial characteristics.

The feature extractor 162 determines a region of a radius around each vertex associated with the point cloud and one or more principal components for a subset of 3D points in the region associated with the point cloud. The feature extractor 162 determines a principle Eigenvector from the determined one or more principle components. The feature extractor 162 determines the mean depth of the subset of 3D points in the region around each vertex.

The feature extractor 162 propagates a vertex along with one or more geometrical features and one or more spatial features through a series of encoding layers of the neural network. The feature extractor 162 propagates the one or more geometrical features and the one or more spatial features through encoding layers, where the encoding layers learn to understand underlying geometry in the point cloud using the one or more geometrical features and the one or more spatial features, and outputs an encoded feature vector that is passed onto subsequent layers. According to an embodiment, the geometry in the point cloud may be a corner, an edge or a ridge in the point cloud. However, the disclosure is not limited thereto. According to an example embodiment, the feature extractor 162 determines that the encoded feature vector is half of the input to that particular layer. The feature extractor 162 determines the global feature vector which encodes all information after data is propagated through multiple encoding layers.

The attention-similarity controller 163 determines the one or more similarity scores of each vertex associated with the point cloud based on the determined normal vector and the determined one or more spatial features. In other words, the attention-similarity controller 163 determines the one or more similarity scores for each vertex based on the normal vector/direction, the mean depth, and the Eigenvectors. For example, the attention-similarity controller 163 determines the one or more similarity scores for each vertex by using the multiplication of the inverse of the normal vector/direction, the mean depth, and the Eigenvectors to an exponent, as shown in the equation (1).

Similarity Score=Πe^{-value} (1)

In equation (1), the value indicates the mean depth, the normal vector, and the Eigenvector. The attention-similarity controller 163 determines the one or more attention scores based on the determined normal vector, the determined one or more spatial features and/or the one or more similarity scores. According to an example embodiment, the one or more attention scores are learned using a fully connected layer of a neural network from the one or more similarity scores and updated during a backward propagation of loss. Furthermore, the attention-similarity controller 163 determines the one or more attention scores for a given input feature vector (e.g., N*D) and provides the one or more attention scores for each node of each layer of the neural network. The attention-similarity controller 163 determines a global feature vector. For example, the attention-similarity controller 163 determines a global feature vector based on the determined normal vector, the determined one or more spatial features, the one or more similarity scores and the one or more attention scores. And then, the attention-similarity controller 163 segments the point cloud based on the determined normal vector, the determined one or more spatial features, the one or more similarity scores, the one or more attention scores, and the global feature vector.

The function associated with the AI engine 164 (or AI/ML model) may be performed through the non-volatile memory, the volatile memory, and the processor 120. One or a plurality of processors controls the processing of the input data in accordance with a predefined operating rule or AI model stored in the non-volatile memory and the volatile memory. The predefined operating rule or AI model is provided through training or learning. Here, being provided through learning means that, by applying a learning algorithm to a plurality of learning data, a predefined operating rule or AI engine 164 of the desired characteristic is made. The learning may be performed in a device itself in which AI according to an example embodiment is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI engine 164 may include a plurality of neural network layers. Each layer has a plurality of weight values and performs a layer operation through a calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and Deep Q-Networks.

According to an embodiment, the view engine 165 detects an input from a user of the electronic device 100 to place an object (i.e., a first object) in the virtual environment based on the segmented point cloud. According to an example embodiment, the first object may be a chair. The view engine 165 determines an optimal empty location to place the object in the virtual environment based on the segmented point cloud. The view engine 165 determines the scale and orientation of the object in the optimal empty location. The view engine 165 determines a Model View and Projection Matrix (MVP) based on the determined scale and the determined orientation of the object. After the user selects the optimal location, it may be determined that the optimal location contains another object. When it is determined that the optimal location contains another object (i.e., a second object), the second object can be removed from the optimal location using the segmented point cloud. The user's view of the actual object may also be obstructed (or occluded) by other objects (i.e., third objects) in the point cloud. In order to provide the user with a clear view, these obstructing third objects must also be removed. As a result, the segmented point cloud can be used to achieve the same result. That is, the one or more third objects can be removed using the segmented point cloud so as not to obstruct the view of the user. The view engine 165 determines a shading map for the objects through real-world illumination and on removal of obstructions from other real world objects (using the segmented point cloud). The shading map in turn is used for simulating the overall effect of several light sources for present scene to generate a more photorealistic 3D Object. The view engine 165 displays the virtual environment by placing the object in the optimal empty location of the virtual environment.

The view engine 165 further detects the viewing direction of the user of the electronic device 100 looking at the one or more segmented objects in the virtual environment. The viewing direction provides the information about the angle from which the segmented object is being viewed, and is used to update the associated view matrix. The view engine 165 determines the one or more optimal empty locations associated with the detected viewing direction in the virtual environment using the segmented point cloud, where the one or more optimal empty locations includes a planar surface associated with the determined viewing direction in the segmented point cloud along with depth information of the planar surface for a correct placement of the one or more segmented objects.

Although the view engine 165 detects an input to place an object in the virtual environment according to an example embodiment, the disclosure is not limited to one input or one object. As such, according to another example embodiment, the view engine 165 may detect one or more inputs to place a plurality of objects in the virtual environment based on the segmented point cloud. In this case, the view engine 165 may determine a plurality of optimal empty locations to place the respective objects in the virtual environment based on the segmented point cloud.

Although the FIG. 1 shows various hardware components of the electronic device 100 but it is to be understood that other embodiments are not limited thereon. In other embodiments, the electronic device 100 may include less or a greater number of components. Further, the labels or names of the components are used only for illustrative purpose and does not limit the scope of the invention. One or more components can be combined to perform the same or substantially similar functions for segmenting the point cloud.

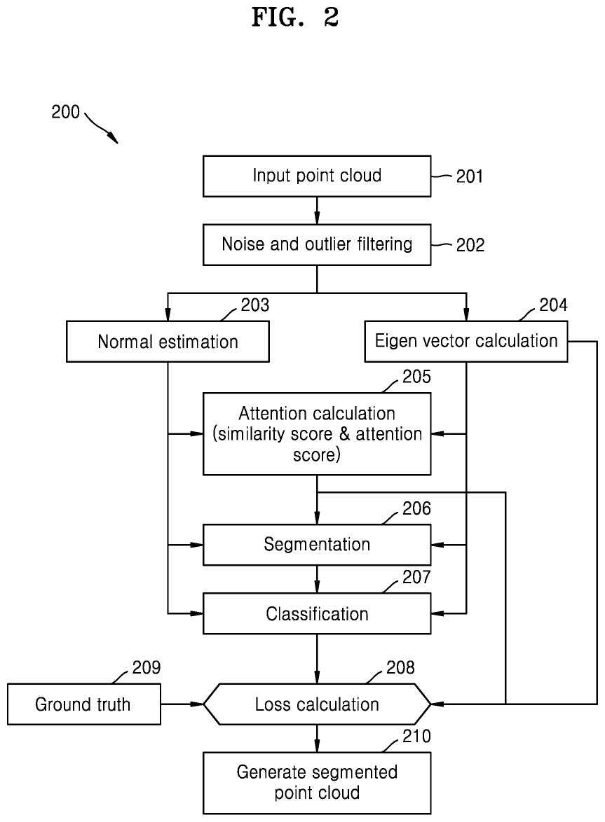

FIG. 2 is a flow diagram 200 illustrating a method for segmenting the point cloud, according to an example embodiment of the disclosure. The electronic device 100 performs various operations for segmenting the point cloud as illustrated in FIG. 2.

At operation 201, the method includes receiving a point cloud that includes colorless data and/or featureless data. According to an embodiment, the point cloud is generated by using a plurality of image frames of the real-world environment captured using a sensor or a camera of the electronic device 100. At operation 202, the method includes filtering the noise and/or the outlier from the received point cloud by applying, for example, the adaptive filter and/or the selective filter. At operation 203, the method includes determining the normal vector for the received point cloud, and at operation 204, the method includes determining one or more spatial features for the received point cloud. According to an example embodiment, the one or more spatial features may be an Eigen vector. At operation 205, the method includes determining the one or more similarity scores of each vertex associated with the point cloud based on the determined normal vector and/or the determined one or more spatial features. Further, the method includes determining the one or more attention scores for the determined normal vector, determined one or more spatial features, and one or more similarity scores. The attention is used in assigning weightage to different associated features during forward propagation while training the AI engine.

At operation 206-207, the method includes segmenting and/or classifying the point cloud based on the determined normal vector, the determined one or more spatial features, the determined one or more similarity scores, and the determined one or more attention scores. At operation 208, the method includes determining a loss using ground truth 209. At operation 210, the method includes updating the determined one or more attention scores during backward propagation of loss and generating the segmented point cloud.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

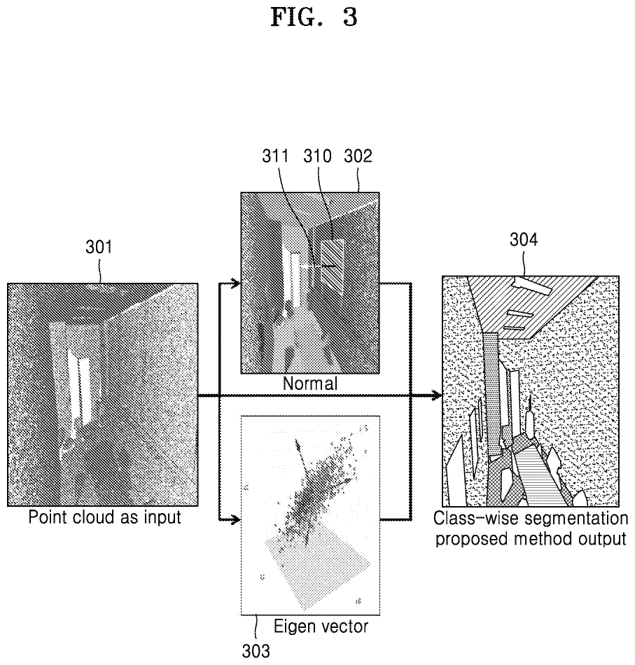

FIG. 3 is an example flow diagram illustrating various operations for segmenting the point cloud, according to an example embodiment of the disclosure.

At operation 301, the segmentation controller 160 receives the point cloud that includes colorless data and featureless data (e.g., without RGB values), where the point cloud is determined based on the plurality of image frames of the real-world environment. For example, the real-world environment maybe an office environment. The plurality of image frames may be captured using the sensor of the electronic device 100. The segmentation controller 160 filters or removes the noise and/or the outlier from the received point cloud by applying, for example, the adaptive filter and/or the selective filter. The segmentation controller 160 filters or removes the noise and/or the outlier by eliminating points that are at a distance more than the known threshold value.

At operation 302, the segmentation controller 160 determines the normal vector 311 of the plane 310 tangent to the surface around each vertex associated with the received point cloud, where the received point cloud is obtained at each encoder layer of the neural network while training. At operation 303, the segmentation controller 160 determines the one or more spatial features (e.g., mean depth, Eigenvector, etc.) by analyzing the surrounding surface associated with the received point cloud, where the received point cloud is obtained at each encoder layer of the neural network while training.

At operation 304, the segmentation controller 160 concatenates the normal vector and the one or more spatial features as additional features to provide supervision at each encoding layer of the neural network while training. The segmentation controller 160 then determines the one or more similarity scores of each vertex associated with the point cloud based on the determined normal vector and the determined spatial feature, and determines the one or more attention scores based on the determined normal vector and/or the determined spatial feature and/or the one or more similarity scores. The segmentation controller 160 then determines the global feature vector and segments/classifies the point cloud based on the one or more similarity scores, the one or more attention scores, and the global feature vector. According to an example embodiment, the global feature vector may include one or more global features, which may be decoded with a skip connection to provide the segmented point cloud with dimension information. For example, the dimension information may include an information about N×C dimension where N is a number of the vertex in a filtered point cloud and C is a number of classes for which the segmentation was performed.

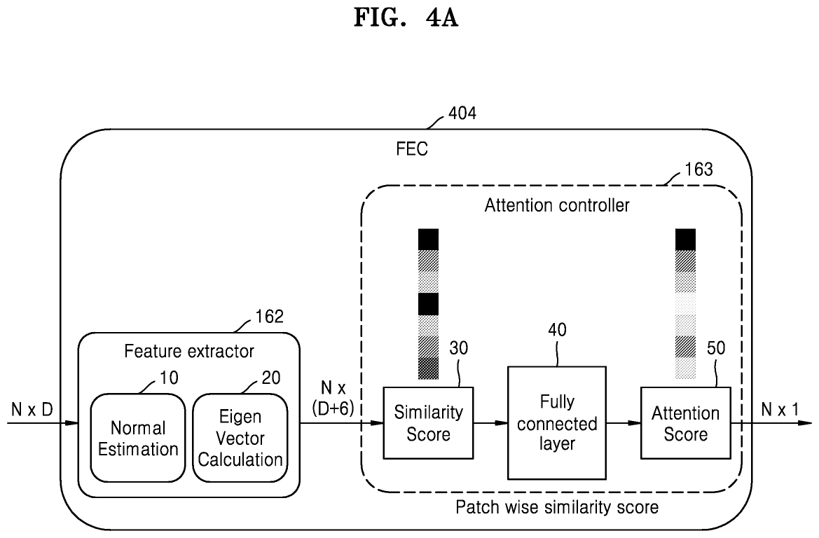

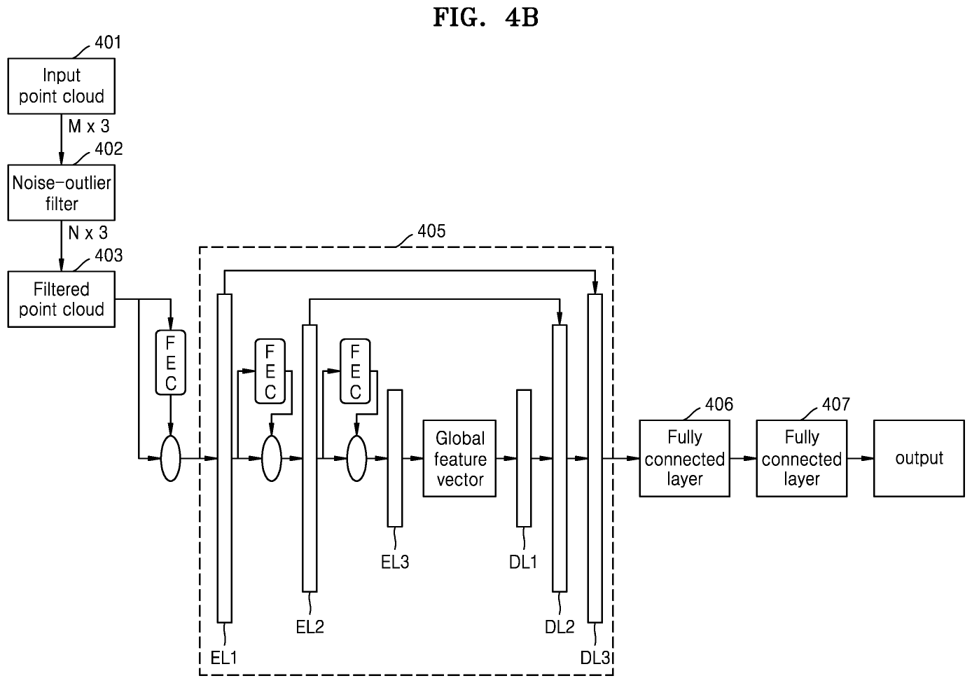

FIG. 4A is an example flow diagram illustrating various operations for Feature Extraction and Attention Calculation, according to another embodiment of the disclosure. Normal estimation 10 is calculated for each vertex in the point cloud. In other words, the feature extractor 162 determines the normal vector of the plane tangent to the surface around each and every vertex. The normal estimation 10 incorporates global orientation information. The normal estimation 10 fits a 3D surface to the vertex using a region around this vertex such that the surface has the least outliers. Upon finding such a surface, the normal estimation 10 finds a plane tangential to the estimated surface. The normal vectors of this plane are used as the normal of the vertices. The eigen vector is calculated for each vertex in the point cloud. The eigen vector calculation 20 incorporates local prominent orientation. The eigen vector calculation 20 takes into consideration a region around the vertex, and performs a principal component analysis on the points around the region. The significance of eigen values is given below:

a) A vertex with three prominent eigen vectors represents a corner. As the points around the vertex are aligned such that the variability is minimum along all the 3 axes, i.e. X, Y, Z.

b) A vertex with two prominent eigen vectors represents a plane. As the points around the vertex are aligned such that the variability is minimum along two axes, i.e. either of X-Y, Y-Z, Z-X.

c) A vertex with one prominent eigen vector represents an edge. As the points around the vertex are aligned such that the variability is minimum along a single axis, i.e. either of X, Y, Z. The X, Y, Z are just representative of the different axis, the eigen vector can be any combination of these vectors such that the vectors are orthonormal.

The mean depth is calculated for each vertex in the point cloud. In an example embodiment, the feature extractor 162 may include mean depth block. The mean depth block takes into consideration a region around the vertex and finds the mean of all the points in the region along the direction of the most prominent eigen vector. As the eigen vector will incorporate a local orientation around the point.

In other words, the feature extractor 162 determines the normal vector of the plane tangent to the surface around each and every vertex at normal estimation 10. And the feature extractor 162 determines the one or more spatial features such as mean depth, Eigenvector, etc. specifically, the feature extractor 162 determines the Eigenvectors of the surrounding surface for each vertex at Eigenvector calculation 20, and the mean depth of the subset of 3D points in the region around each vertex at mean depth block.

The similarity score is calculated for each vertex in the point cloud. The similarity score block 30 takes as input the estimated normal, eigen vectors along with mean depth and calculates a similarity score which is the multiplication of the inverse of these input to the power of e.

The attention score 50 is calculated using a fully connected layer 40 using the similarity score 30 as input.

The motivation behind the attention score 50 is given below:

a) Attention score 50 will make the network adaptable to numerous use cases. For example, if the problem involves classifying various planes in the scene, then more attention should be given in order normal direction, mean depth and then eigen values but if the problem involves segmentation then the attention should be in order eigen values, mean depth and then normal direction.

b) The eigen values calculated by the feature extractor 162 will help in cases where precise segmentation is required, the network can learn to understand the labelling of the different parts of a point cloud using the edge between them.

c) Based on cases, the fully connected layers can adapt to the use case and provide supervision to the AI engine such that the network converges to the given problem.

FIG. 4B is an example flow diagram illustrating various operations for segmenting the point cloud, according to another embodiment of the disclosure. At operation 401, Feature Extraction and Attention Calculator (FEC) block takes as input the point cloud with embedded features, estimates normal, eigen values and mean depth for all the points. These newly estimated features will be appended to the existing embedded features and passed onto a similarity score calculator. After the similarity scores 30 are calculated, it is passed through the fully connected layer 40 to calculate the attention score 50 which will then be fed to the AI engine for supervision.

Feature extraction block 405 represents an encoder-decoder configuration which uses attention-based supervision to adapt to the given problem. At each encoding block, the output from the previous layer is passed to the Feature Extraction and Attention Calculator (FEC) block. The attention calculated will then be appended to the output from the previous layer and is then processed by the next encoding block. For example, the output from the encoding layer EL2 is passed to the Feature Extraction and Attention Calculator (FEC) block. The attention calculated in the FEC block will then be appended to the output from the encoding layer EL2 and is then processed by the next encoding layer EL3.

Each encoding layer EL1, EL2 and EL3 reduces the number of points and increases the number of features embedded with each point. After multiple encoding blocks, a global feature vector is generated which incorporated all the significant information. After this step, The global feature vector is passed through decoding layers DL1, DL2 and DL3. The decoding layers DL1, DL2 and DL3 increase the points such that they match with the count of the respective encoding layer EL1, EL2 and EL3. All the decoding layers DL1, DL2 and DL3 are linked with the encoding layers EL1, EL2 and EL3 with a skip connection to avoid the dying gradient problem. The output of the final decoding layer DL3 is passed through fully connected layers 406 and 407, to find the final label.

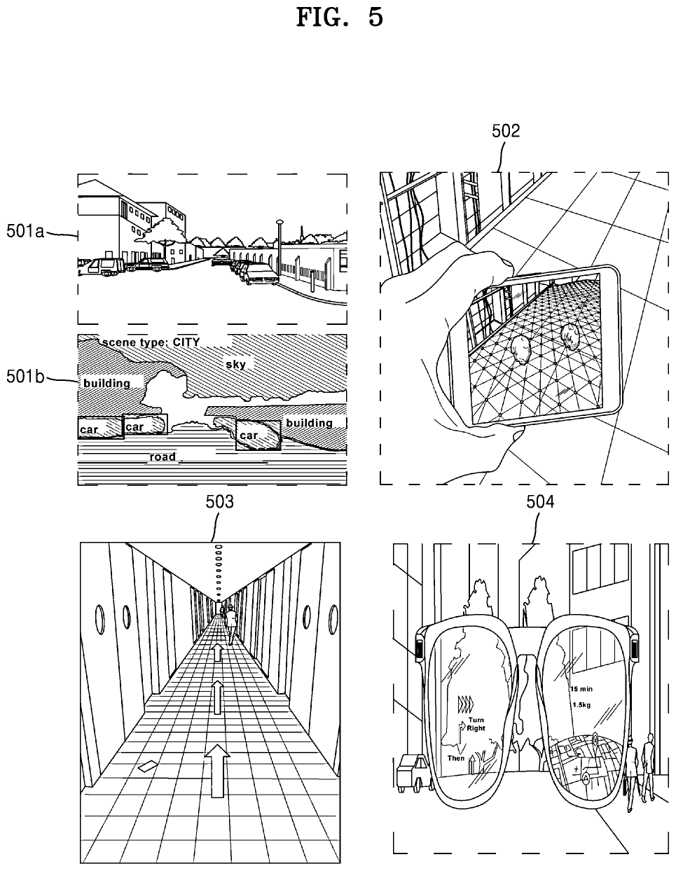

FIG. 5 illustrates various use cases for implementing the point cloud segmentation method, according to an example embodiment of the disclosure.

According to an example embodiment, the point cloud segmentation method may be implemented in a first scenario 501a, to comprehend a real-world environment through scene segmentation 501b (e.g., scene type as “city”, building, car, sky, road, and so on). According to another example embodiment, the point cloud segmentation method may be implemented in a second scenario 502, to place/display one or more objects (e.g., an AR object) in the virtual environment. Here, the one or more objects may be placed in an optimal empty location of the virtual environment (e.g., AR/VR scenes, Metaverse, etc.). According to another example embodiment, the point cloud segmentation method may be implemented in a third scenario 503 to navigate through an area in an indoor facility or in a fourth scenario 504 to navigate through an area in an outdoor environment. Here, walkable areas can be segmented and used when calculating the navigation path given source and destination.

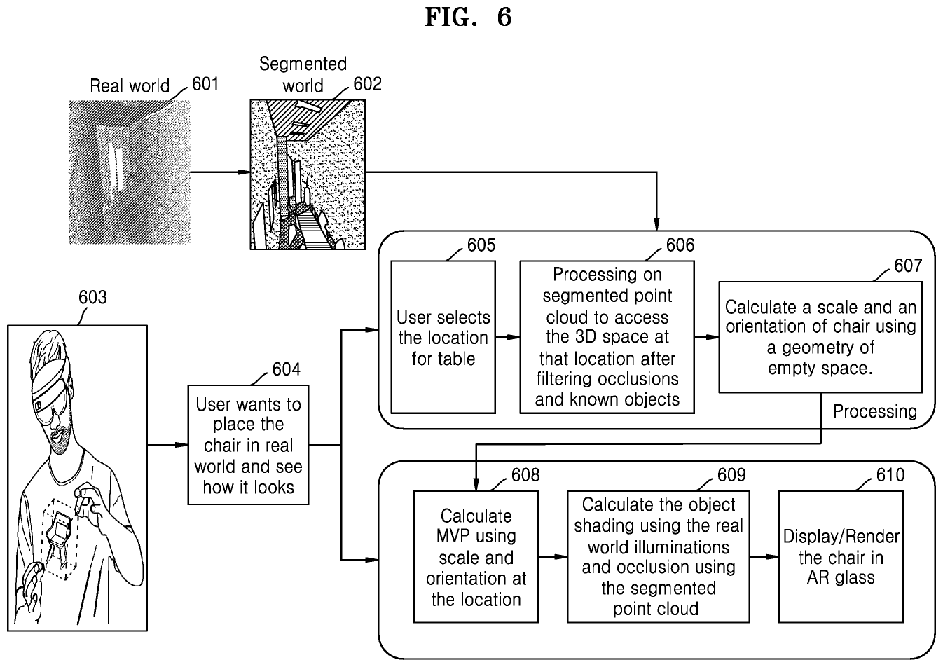

FIG. 6 illustrates an example scenario in which the user of the electronic device 100 places an object at an optimal location in the virtual environment based on the segmented point cloud, according to an example embodiment of the disclosure.

At operation 601, the segmentation controller 160 determines the point cloud based on the plurality of image frames of the real-world environment (i.e. office environment). Here, the plurality of image frames are captured using the sensor of the electronic device 100. At operation 602, the segmentation controller 160 generates the segmented/classified point cloud based on the one or more similarity scores, the one or more attention scores, and the global feature vector. At operations 603-606, the segmentation controller 160 detects one or more inputs from the user of the electronic device 100 to place the object (e.g., chair) in the virtual environment based on the segmented point cloud and determines the optimal empty location (e.g., location near table) to place the object in the virtual environment based on the segmented point cloud.

According to an example embodiment, at operation 603, the segmentation controller 160 may receive an input related to the user's interaction with the chair in AR. At operation 604, the segmentation controller 160 may receive an input from the user indicating that the user would like to place the chair to visualize the chair in a real world environment. At operation 605, the segmentation controller 160 receives a selection from the user indicating a location for the table. At operation 605, the segmentation controller 160 performs processing on the segmented point cloud to access the 3D space at that location after filtering occlusions and known objects.

At operation 607, the segmentation controller 160 determines the scale and the orientation of the object in the optimal empty location (e.g., available/empty location near table). At operation 608, the segmentation controller 160 determines the MVP based on the determined scale and the determined orientation of the object. At operation 609, the segmentation controller 160 determines the shade of the object based on a real-world illustration and an occlusion based on the segmented point cloud. At operation 610, the segmentation controller 160 displays the virtual environment by placing the object in the optimal empty location of the virtual environment.

In an example embodiment, the method includes determining, by the electronic device 100, the determined scale and the determined orientation of the at least one object in the optimal empty location. The method further includes determining, by the electronic device 100, a Model View and Projection Matrix (MVP) based on the determined scale and the determined orientation of the at least one object. The method further includes determining, by the electronic device 100, a shade of the at least one object based on a real-world illustration and an occlusion of at least one real-world object based on the segmented point cloud.

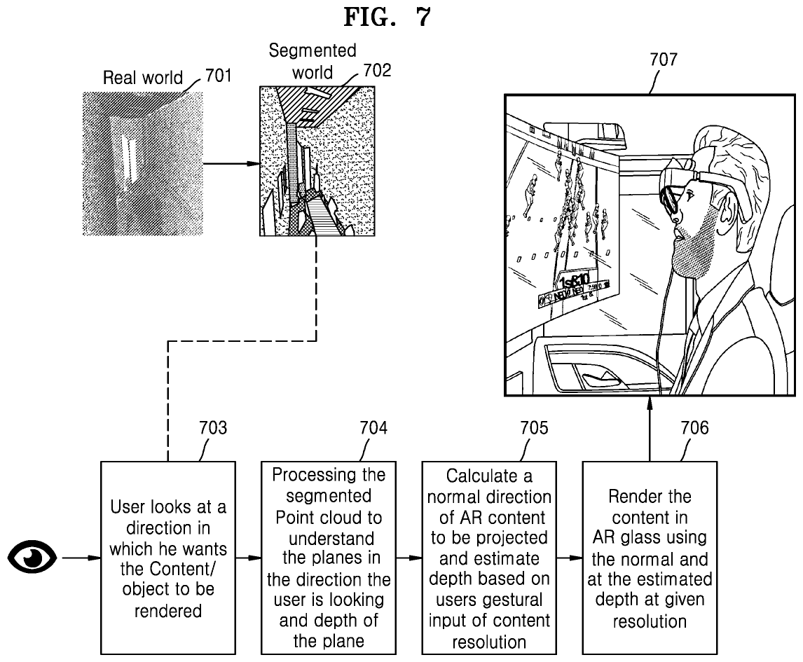

FIG. 7 illustrates an example scenario in which the user of the electronic device 100 sees an object at an optimal location in the virtual environment based on the segmented point cloud, according to an example embodiment of the disclosure.

At operation 701, the segmentation controller 160 determines the point cloud based on the plurality of image frames of the real-world environment (i.e. office environment), the plurality of image frames is captured using the sensor of the electronic device 100. At operation 702, the segmentation controller 160 generates the segmented/classified point cloud based on the one or more similarity scores, the one or more attention scores, and the global feature vector. At operation 703, the segmentation controller 160 detects a viewing direction of the user. According to an example embodiment, the segmentation controller 160 may use an existing mechanism to detect the viewing direction of the user. Here the viewing direction may be associated with the user of the electronic device viewing object/content (e.g., rugby game) in the virtual environment based on the segmented point cloud. At operations 704-705, the segmentation controller 160 determines the optimal empty location associated with the detected looking direction to see/project the object/content in the virtual environment based on the segmented point cloud, where the optimal empty location includes the plane associated with the detected looking direction in the segmented point cloud and depth information of the plane. The depth information of the plane is determined based on a user gesture input of object/content resolution.

According to an example embodiment, at operation 704, the segmentation controller 160 may process the segmented point cloud to obtain the planes in the viewing direction of the user and depth of the planes. At operation 705, the segmentation controller 160 may calculate a normal direction of an AR content to be projected and estimate depth based on user's input regarding the content. For example, the user input may be related to content resolution. At operation 706, the segmentation controller 160 may render the content in AR glass using the normal direction and at the estimated depth based on the input information regarding the content. For example, the segmentation controller 160 may render the content in AR glass using the normal direction and at the estimated depth at the input resolution.

At operation 707, the segmentation controller 160 displays the virtual environment with the object/content in the optimal empty location of the virtual environment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for performing point cloud segmentation, the method comprising:
receiving, by an electronic device, a point cloud comprising at least one of colorless data and featureless data;
determining, by the electronic device, at least one of one or more normal vectors and one or more spatial features for one or more vertices in the point cloud; and
segmenting, by the electronic device, the point cloud based on the at least one of the one or more normal vectors and the one or more spatial features.

2. The method as claimed in claim 1, wherein the method further comprises:
detecting, by the electronic device, at least one input from a user of the electronic device to place at least one object in a virtual environment;
determining, by the electronic device, an optimal empty location to place the at least one object in the virtual environment based on the segmented point cloud; and
displaying, by the electronic device, the virtual environment comprising the at least one object placed in the optimal empty location of the virtual environment.

3. The method as claimed in claim 1, wherein the segmenting the point cloud based on the at least one of the one or more normal vectors and the one or more spatial features comprises:
determining a similarity score for the one or more vertices in the point cloud based on the at least one of the one or more normal vectors and the one or more spatial features;
determining an attention score based on the at least one of the one or more normal vectors, the one or more spatial features, and the similarity score;
determining a global feature vector of the point cloud based on the at least one of the one or more normal vectors, the one or more spatial features, the similarity score, and the attention score; and
segmenting the point cloud based on at least one of the similarity score, the attention score, and the global feature vector.

4. The method as claimed in claim 3, wherein the attention score is generated using Fully Connected (FC) layers of at least one neural network.

5. The method as claimed in claim 3, further comprising:
updating, by the electronic device, the attention score by updating weights of Fully Connected (FC) layers of at least one neural network by back-propagating a loss determined using a segmentation controller such that a new attention score is determined in a next iteration; and
repeating the updating operation until training is completed,
wherein the loss incorporates Eigen values to provide accurate segmentation around at least one edge and at least one corner in the point cloud.

6. The method as claimed in claim 2, wherein the displaying the virtual environment comprising the at least one object placed in the optimal empty location of the virtual environment comprises:
determining a scale and an orientation of the at least one object in the optimal empty location;
determining a Model View and Projection Matrix (MVP) based on the determined scale and the determined orientation of the at least one object; and
determining a shade of the at least one object based on a real-world illustration and an occlusion of at least one real-world object based on the segmented point cloud.

7. The method as claimed in claim 1, wherein the receiving the point cloud comprising the at least one of the colorless data and the featureless data comprises:
capturing a plurality of image frames of a real-world environment using at least one sensor of the electronic device; and
determining the point cloud of the real-world environment from the plurality of image frames using at least one image processing mechanism.

8. The method as claimed in claim 1, wherein the determining the one or more normal vectors for the one or more vertices in the point cloud comprises:
filtering at least one of a noise and an outlier from the point cloud by applying at least one of an adaptive filter and a selective filter;
determining a plane tangent to a surface around each of the one or more vertices in the point cloud; and
determining the one or more normal vectors based on the determined plane tangent.

9. The method as claimed in claim 1, wherein the determining the spatial feature for the received point cloud comprises:
filtering at least one of a noise and an outlier from the point cloud by applying at least one of an adaptive filter and a selective filter;
determining a region of a first radius around each vertex in the point cloud and at least one principal component for a subset of three dimensional (3D) points in the region;
determining at least one principle Eigen vector from the at least one determined principle component; and
determining a mean depth of the subset of 3D points in the region around each of the one or more vertices.

10. The method as claimed in claim 1, wherein the determining the global feature vector comprises:
propagating at least one vertex, among the one or more vertices in the point cloud, along with geometrical features and the one or more spatial features through a series of encoding layers of at least one neural network, wherein each of the series of encoding layers obtains geometry information in the point cloud using the geometrical features and the one or more spatial features, and outputs an encoded feature vector that is passed onto a subsequent encoding layer, among the series of encoding layers;
determining that the encoded feature vector is half of the input to that particular layer; and
determining the global feature vector by encoding information passed through multiple encoding layers, among the series of encoding layers.

11. The method as claimed in claim 1, further comprising:
detecting, by the electronic device, a viewing direction of a user using the electronic device to see at least one object in a virtual environment based on the segmented point cloud;
determining, by the electronic device, an optimal empty location associated with the viewing direction based on the segmented point cloud, wherein the optimal empty location comprises at least one plane associated with the viewing direction in the segmented point cloud and depth information of the at least one plane; and
displaying, by the electronic device, the virtual environment with the at least one object in the optimal empty location of the virtual environment.

12. An electronic device comprising:
a memory;
a segmentation controller, coupled to the memory, and configured to:
receive a point cloud comprising at least one of colorless data and featureless data;
determine at least one of one or more normal vectors and one or more spatial features for one or more vertices in the point cloud; and
segment the point cloud based on the at least one of the one or more normal vectors and the one or more spatial features.

13. The electronic device as claimed in claim 12, wherein the segmentation controller further configured to:
detect at least one input from a user of the electronic device to place at least one object in a virtual environment;
determine an optimal empty location to place the at least one object in the virtual environment based on the segmented point cloud; and
display the virtual environment comprising the at least one object placed in the optimal empty location of the virtual environment.

14. The electronic device as claimed in claim 12, wherein the segmentation controller further configured to:
determine a similarity score for the one or more vertices in the point cloud based on the at least one of the one or more normal vectors and the one or more spatial features;
determine an attention score based on the at least one of the one or more normal vectors, the one or more spatial features, and the similarity score;
determine a global feature vector of the point cloud based on the at least one of the one or more normal vectors, the one or more spatial features, the similarity score, and the attention score; and
segment the point cloud based on at least one of the similarity score, the attention score, and the global feature vector.

15. The electronic device as claimed in claim 14, wherein the attention score is generated using Fully Connected (FC) layers of at least one neural network.

16. The electronic device as claimed in claim 14, wherein the segmentation controller further configured to:
update the attention score by updating weights of Fully Connected (FC) layers of at least one neural network by back-propagating a loss determined such that a new attention score is determined in a next iteration; and
repeat the updating operation until training is completed,
wherein the loss incorporates Eigen values to provide accurate segmentation around at least one edge and at least one corner in the point cloud.

17. The electronic device as claimed in claim 13, wherein the segmentation controller further configured to:
determine a scale and an orientation of the at least one object in the optimal empty location;
determine a Model View and Projection Matrix (MVP) based on the determined scale and the determined orientation of the at least one object; and
determine a shade of the at least one object based on a real-world illustration and an occlusion of at least one real-world object based on the segmented point cloud.

18. The electronic device as claimed in claim 12, wherein the electronic device further comprises:
at least one sensor;
wherein the segmentation controller further configured to:
capture a plurality of image frames of a real-world environment using the at least one sensor; and
determine the point cloud of the real-world environment from the plurality of image frames using at least one image processing mechanism.

19. The electronic device as claimed in claim 12, wherein the segmentation controller further configured to:
filter at least one of a noise and an outlier from the point cloud by applying at least one of an adaptive filter and a selective filter;
determine a plane tangent to a surface around each of the one or more vertices in the point cloud; and
determine the one or more normal vectors based on the determined plane tangent.

20. A non-transitory computer-readable storage medium, having a computer program stored thereon that performs, when executed by a processor, the method according to claim 1.
